(19) United States
(12) Patent Application Publication
(10) Pub. No.: US 2026/0211302 A1
(43) Pub. Date: Jul. 23, 2026

(54) CAMERA MODULE

(71) Applicant: SAMSUNG ELECTRO-MECHANICS CO., LTD., Suwon-si (KR)

(72) Inventors: Jung Woo KIM, Suwon-si (KR); Soo Cheol LIM, Suwon-si (KR); Jae Kyung KIM, Suwon-si (KR)

(73) Assignee: SAMSUNG ELECTRO-MECHANICS CO., LTD., Suwon-si (KR)

(21) Appl. No.: 19/397,520

(22) Filed: Nov. 21, 2025

(30) Foreign Application Priority Data
Jan. 20, 2025 (KR) 10-2025-0008289

(51) Int. Cl. G03B 17/17; G03B 5/00

(52) U.S. Cl. CPC G03B 17/17; G03B 5/00; G03B 2205/0023

(57) ABSTRACT

A camera module includes a reflective module. The reflective module includes a housing, a reflective configured to rotate about a first axis, a reflective member disposed on the reflective holder, a rotating carrier configured to rotate about a second axis perpendicular to the first axis, wherein the reflective holder is disposed on the rotating carrier, a first ball group disposed between the reflective holder and the rotating carrier and including a plurality of ball members spaced apart from the first axis, and a second ball group disposed between the rotating carrier and the housing and including a plurality of ball members spaced apart from the second axis. The first axis and the second axis pass through the rotating carrier.

### CROSS-REFERENCE TO RELATED APPLICATIONS

This application claims the benefit under 35 USC 119(a) of Korean Patent Application No. 10-2025-0008289 filed on January 20, 2025, in the Korean Intellectual Property Office, the entire disclosure of which is incorporated herein by reference for all purposes.

### BACKGROUND

### 1. Field

The present disclosure relates to a camera module.

### 2. Description of the Background

A camera module may have a structure in which a lens is disposed on the upper side of a reflective member.

To avoid resolution degradation in this lens-lead type camera module, the rotation center of the reflective member, for example, the yaw axis, may be aligned with the optical axis of the lens (hereinafter, the lead lens) disposed on the upper side of the reflective member when performing image stabilization.

Meanwhile, a pivot structure may be employed to align the yaw axis of the reflective member with the optical axis of the lead lens, but the pivot structure may have limitations in correcting minute shaking.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a reflective module. The reflective module includes a housing, a reflective holder configured to rotate about a first axis, a reflective member disposed on the reflective holder, a rotating carrier configured to rotate about a second axis perpendicular to the first axis, wherein the reflective holder is disposed on the rotating carrier, a first ball group disposed between the reflective holder and the rotating carrier and including a plurality of ball members spaced apart from the first axis, and a second ball group disposed between the rotating carrier and the housing and including a plurality of ball members spaced apart from the second axis. The first axis and the second axis pass through the rotating carrier.

The camera module may further include a first lens module containing at least one lens disposed in a first optical axis direction and disposed apart from the reflective module in the first optical axis direction, wherein the first optical axis direction may be parallel to the second axis.

The first lens module may be a fixed member coupled to the housing, and the reflective module may be configured to rotate relative to the housing and the first lens module.

The reflective holder may include first guide rails having an arc shape centered on the first axis and disposed apart from each other in a direction of the first axis, the rotating carrier may include second guide rails having an arc shape centered on the first axis and facing the first guide rails, and the first ball group is disposed between the first guide rails and the second guide rails.

The first ball group may include a plurality of first ball members respectively contacting the first guide rails and the second guide rails, and the plurality of first ball members may be disposed on the first guide rails, and at least one of the plurality of first ball members is disposed on each of the second guide rails.

The second guide rail may include a plurality of rails spaced apart in a rotational direction of the reflective holder, and the first guide rail may face the plurality of rails.

The first ball group may further include one or more second ball members each having a diameter smaller than a diameter of each of the plurality of first ball members, and a number of first ball members of the plurality of first ball members may be greater than a number of second ball members of the one or more second ball members.

A first magnetic member may be disposed on the reflective holder, and a second magnetic member facing the first magnetic member may be disposed on the rotating carrier, and the first magnetic member and the second magnetic member may face each other in an oblique direction to the first axis and the second axis.

The rotating carrier may include a plurality of first guide grooves spaced apart from each other in a circumferential direction of a circle having an arbitrary radius centered on the second axis, the housing may include a plurality of second guide grooves facing the plurality of first guide grooves, and the second ball group may be disposed between the plurality of first guide grooves and the plurality of second guide grooves.

The plurality of first guide grooves and the plurality of second guide grooves may be in a form extending along a rotational direction of the rotating carrier.

The rotating carrier may include a first side surface and a second side surface disposed apart from each other with the reflective member therebetween, the first side surface and the second side surface may be rounded along a rotational direction of the rotating carrier.

A first magnet may be disposed on the first side surface of the rotating carrier, and a second magnet may be disposed on the second side surface of the rotating carrier, and a first coil facing the first magnet may be disposed on the housing.

A third magnetic member may be disposed on the housing to face the first magnet and the second magnet, respectively, and the first magnet and the second magnet may face the third magnetic member in a direction perpendicular to a direction in which the first magnet and the first coil face each other.

The camera module may further include a yoke disposed on the housing to face the first magnet with the first coil interposed therebetween.

The camera module may further include a second lens module including at least one lens disposed in a second optical axis direction, and disposed spaced apart from the reflective module in the second optical axis direction, the second lens module may be configured to move in the second optical axis direction relative to the housing.

In another general aspect, a camera module includes a housing having an internal space, a first lens module including at least one lens, and a reflective module disposed in the internal space and configured to change a path of light passing through the first lens module. The reflective module includes a reflective holder configured to rotate about a first axis, a reflective member disposed on the reflective holder, a rotating carrier configured to rotate about a second axis perpendicular to the first axis, wherein the reflective holder is disposed on the rotating carrier, and a plurality of ball members configured to roll in a rotational direction of the reflective holder and the rotating carrier when the reflective holder and the rotating carrier rotate.

The plurality of ball members may include a first ball group disposed between the reflective holder and the rotating carrier, ball members of the first ball group may be configured to roll along the rotational direction of the reflective holder.

The plurality of ball members may include a second ball group disposed between the rotating carrier and the housing, ball members of the second ball group may be configured to roll along the rotational direction of the rotating carrier.

The first axis and the second axis may pass through the rotating carrier.

Other features and aspects will be apparent from the following detailed description, the drawings, and the claims.

### BRIEF DESCRIPTION OF DRAWINGS

FIG. 1 is a perspective view of a camera module according to one or more embodiments of the present disclosure.

FIG. 2 is a perspective view illustrating a disposed structure of a camera module according to one or more embodiments of the present disclosure.

FIG. 3 is an exploded perspective view of a camera module according to one or more embodiments of the present disclosure.

FIG. 4A, FIG. 4B, FIG. 5A, and FIG. 5B are exploded perspective views of reflective modules according to embodiments.

FIG. 6 is an exploded perspective view of a reflective holder according to one or more embodiments of the present disclosure.

FIG. 7 is a perspective view of a rotating carrier according to one or more embodiments of the present disclosure.

FIG. 8 is a perspective view illustrating a state in which a reflective holder according to one or more embodiments of the present disclosure is supported on a rotating carrier.

FIG. 9A is a cross-sectional view taken along line I-I’ of FIG. 1.

FIG. 9B and FIG. 9C are drawings illustrating a state in which a reflective holder according to one or more embodiments of the present disclosure rotates around a first axis.

FIG. 10 is a cross-sectional view taken along line II-II’ of FIG. 1.

FIG. 11 is an exploded perspective view of a rotating carrier according to one or more embodiments of the present disclosure.

FIG. 12 is a drawing of a bottom surface of a housing according to one or more embodiments of the present disclosure.

FIG. 13A is a plan view of a reflective module according to one or more embodiments of the present disclosure.

FIG. 13B and FIG. 13C are drawings illustrating a rotating carrier according to one or more embodiments of the present disclosure rotating about a second axis.

FIG. 14 is a cross-sectional view taken along line III-III’ of FIG. 1.

FIG. 15 is an exploded perspective view of a lens module according to one or more embodiments of the present disclosure.

FIG. 16 is a perspective view of a main substrate according to one or more embodiments of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Throughout the specification, the X-direction, the Y-direction, and the Z direction refer to the direction parallel to the X-axis, the direction parallel to the Y-axis, and the direction parallel to the Z-axis, respectively, as depicted in the drawings. Also, unless otherwise stated, the X-direction is a concept that includes both the +X-axis direction and the -X-axis direction, which is also applied to the Y-direction and the Z direction.

Throughout the specification, the term “two directions (or axes) being parallel to each other or perpendicular to each other” also includes the case where the two directions (or axes) are substantially parallel or substantially perpendicular. For example, the term “the first axis and the second axis being mutually perpendicular” means that the first axis and the second axis form an angle of 90 degrees or close to 90 degrees.

An aspect of the present disclosure is to provide a camera module capable of compensating even minute shaking.

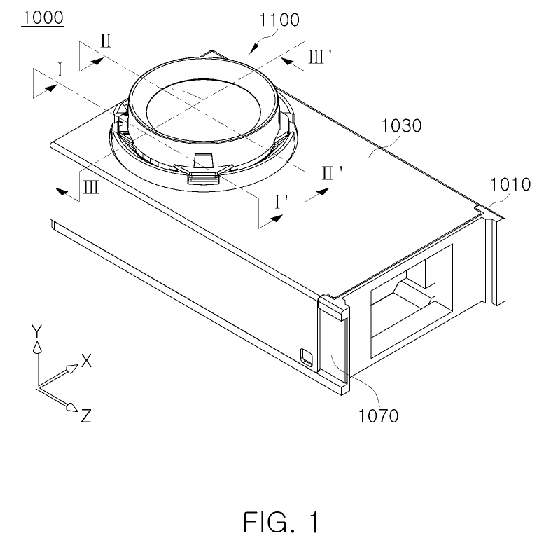

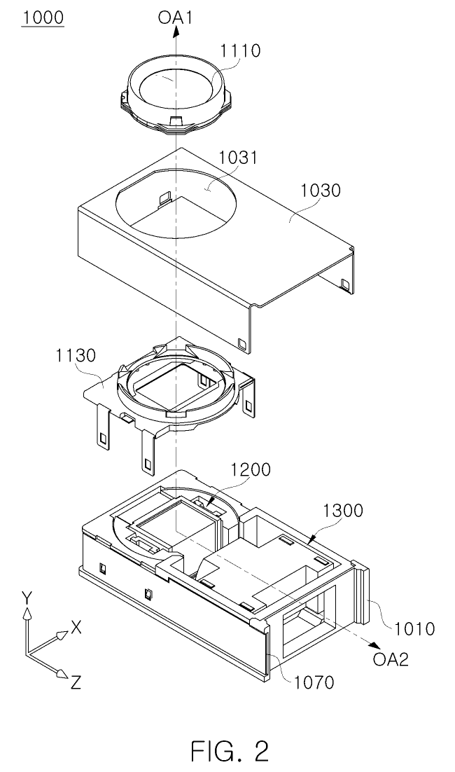

FIG. 1 is a perspective view of a camera module according to one or more embodiments of the present disclosure, and FIG. 2 is a perspective view illustrating a disposed structure of a camera module according to one or more embodiments of the present disclosure.

A camera module 1000 according to one or more embodiments of the present disclosure may be mounted on a portable electronic device such as a smart phone.

Referring to FIG. 1, the X-axis direction, the Y-axis direction, and the Z-axis direction may correspond to the width direction, the height direction, and the length direction of the camera module 100, respectively.

In one or more embodiments of the present disclosure, the height direction (Y-axis direction) of the camera module 1000 may correspond to the thickness direction of the portable electronic device on which the camera module 1000 is mounted. Therefore, the length direction (Z-axis direction) of the camera module 1000 may be relatively free from spatial constraints of the portable electronic device.

Referring to FIG. 2, the camera module 1000 may include a first lens module 1100, a reflective module 1200, and a second lens module 1300.

Light reflected from an external subject may sequentially pass through the first lens module 1100, the reflective module 1200, and the second lens module 1300, and may ultimately reach the image sensor (not illustrated).

The first lens module 1100 may include one or more lenses stacked in the direction of a first optical axis OA1. The direction of the first optical axis OA1 may be parallel to the height direction (Y-axis direction) of the camera module 1000.

The second lens module 1300 may include a plurality of lenses stacked in the direction of a second optical axis OA2. The direction of the second optical axis OA2 may be parallel to the length direction (Z-axis direction) of the camera module 1000 and may be perpendicular to the direction of the first optical axis OA1.

In one or more embodiments of the present disclosure, the second lens module 1300 may include the same number of lenses as that of the first lens module 1100 or a greater number of lenses than that of the first lens module 1100. As described above, since the length direction (Z-axis direction) of the camera module 1000 does not affect the thickness of the portable electronic device, the second lens module 1300 may secure a sufficient number of lenses.

The reflective module 1200 may include a reflective member 1210 that changes the path of incident light. For example, the reflective member 1210 may be provided as a prism or a mirror.

The reflective member 1210 may change the path of incident light from the direction of the first optical axis OA1 to the direction of the second optical axis OA2. The reflective surface of the reflective member 1210 may be disposed obliquely to both the direction of the first optical axis OA1 and the direction of the second optical axis OA2, for example, at an angle of approximately 45 degrees (deg) with respect to the first optical axis OA1 and the second optical axis OA2.

Referring to FIG. 2, the camera module 1000 may include a housing 1010 in which a first lens module 1100, a reflective module 1200, and a second lens module 1300 are disposed.

The housing 1010 may have an internal space, and the reflective module 1200 and the second lens module 1300 may be accommodated in the internal space of the housing 1010. The first lens module 1100 may be coupled to the housing 1010 to cover the internal space that accommodates the reflective module 1200.

In addition, a main substrate 1070 may be attached to the side surface of the housing 1010, and an image sensor may be disposed on another side surface of the housing 1010.

Meanwhile, a shield can 1030 may be coupled to the housing 1010. For example, the shield can 1030 may be coupled to the housing 1010 to cover most of the components provided in the housing 1010. The shield can 1030 may serve to protect the components provided in the housing 1010.

The shield can 1030 may include an opening 1031. The first lens module 1100 may be exposed to the outside through the opening 1031, and thus, light reflected from an external subject may be incident on the first lens module 1100.

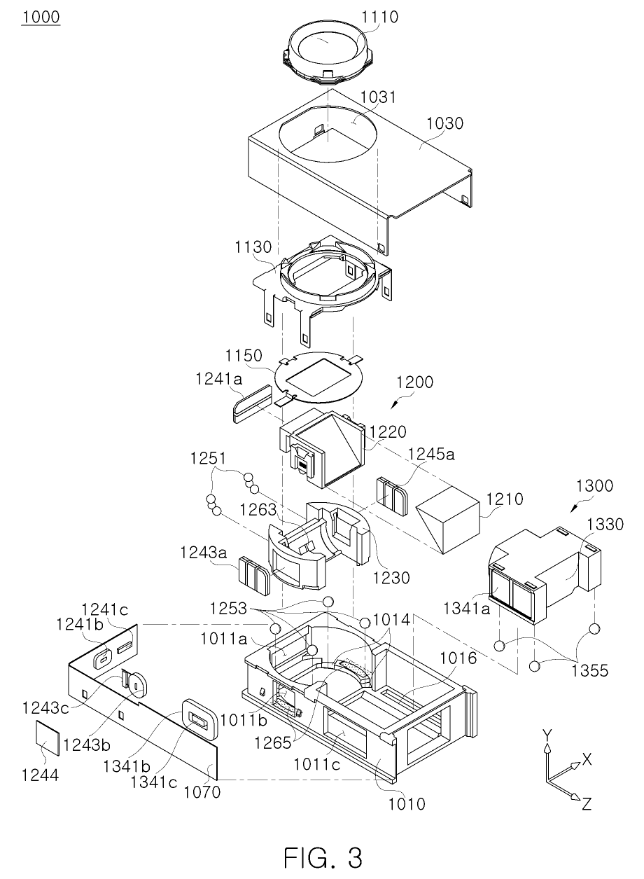

FIG. 3 is an exploded perspective view of a camera module according to one or more embodiments of the present disclosure.

Referring to FIG. 3, the first lens module 1100 may include a first lens barrel 1110 in which one or more lenses stacked in the direction of the first optical axis OA1 are mounted, and a first lens holder 1130 in which the first lens barrel 1110 is mounted.

The first lens barrel 1110 may be disposed to pass through the opening 1031, and since the first lens barrel 1110 is equipped with a lens, light reflected from an external subject may be incident on the lens.

The first lens holder 1130 may be disposed to cover the open upper part of the inner space of the housing 1010 in which the reflective module 1200 is accommodated. The first lens barrel 1110 may be mounted on the first lens holder 1130 so that the reflective module 1200 and the optical axis (the first optical axis OA1) are aligned.

The first lens holder 1130 may be coupled to the housing 1010. Therefore, the first lens module 1100 may be a fixed member.

Meanwhile, a light blocking member 1150 may be disposed below the first lens holder 1130. The light blocking member 1150 may block unnecessary light from among the light incident on the reflective module 1200 through the first lens module 1100.

The light blocking member 1150 may include an opening that is open in the direction of the first optical axis OA1 to allow incident light to pass therethrough, and a peripheral portion that is blackened by attaching a film, coating, or the like. For example, the light blocking member 1150 may be formed of plastic or metal.

The camera module 1000 according to one or more embodiments of the present disclosure may have optical image stabilization. For example, the camera module 1000 may correct shaking by rotating (tilting) the reflective module 1200. The reflective module 1200 may be rotated around a first axis (X-axis) and a second axis (Y-axis) perpendicular to the first axis (X-axis). The first axis (X-axis) may be perpendicular to both the first optical axis OA1 and the second optical axis OA2, and the second axis (Y-axis) may be an axis parallel to the first optical axis OA1.

The first axis (X-axis) and the second axis (Y-axis) may intersect each other. For example, the first axis (X-axis) and the second axis (Y-axis) may intersect at the center of the reflective surface of the reflective member 1210.

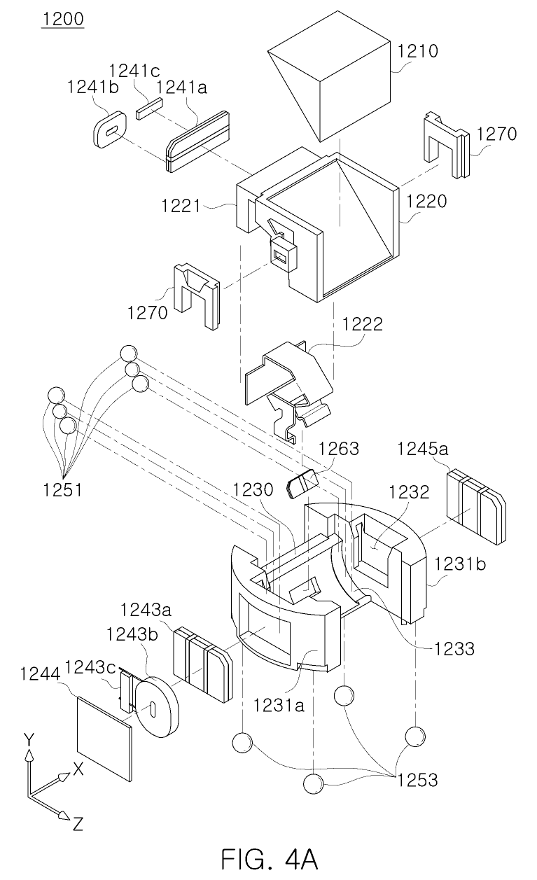

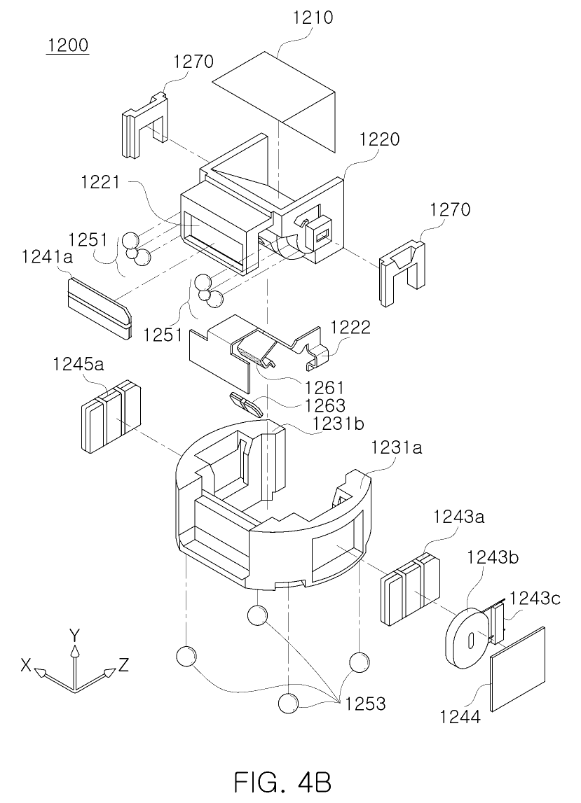

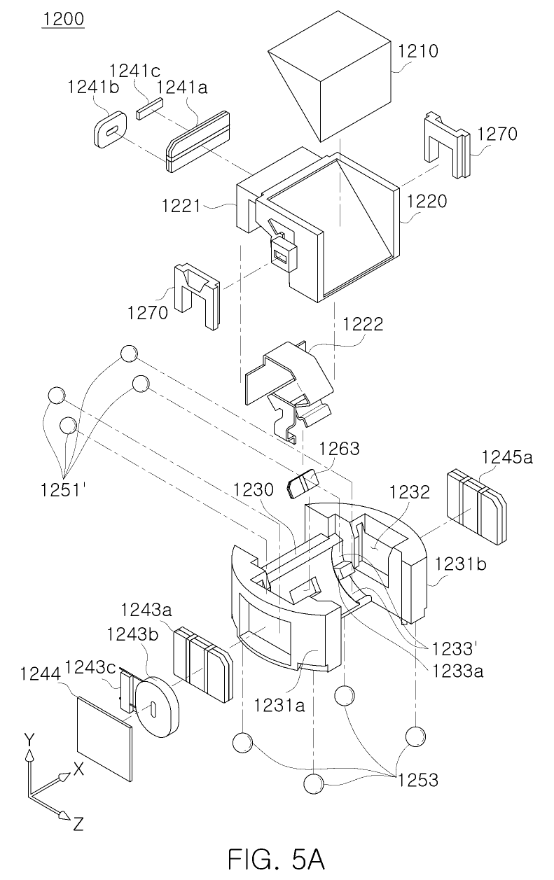

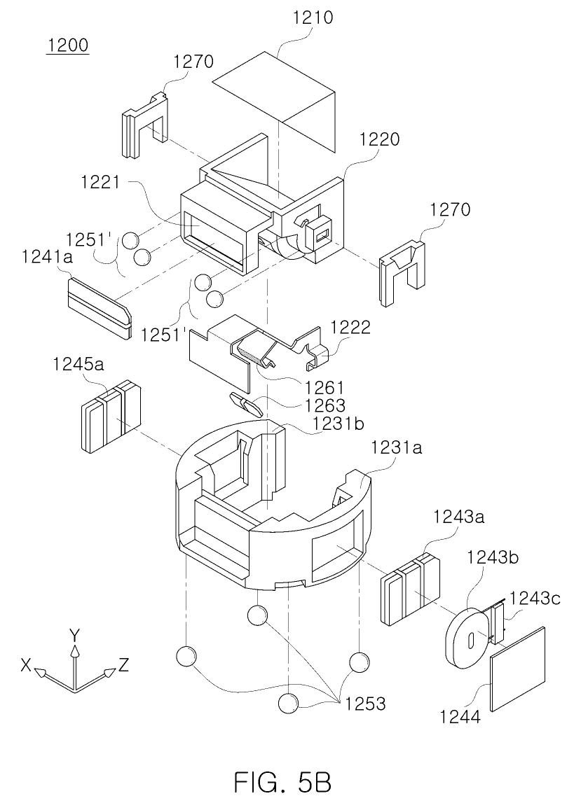

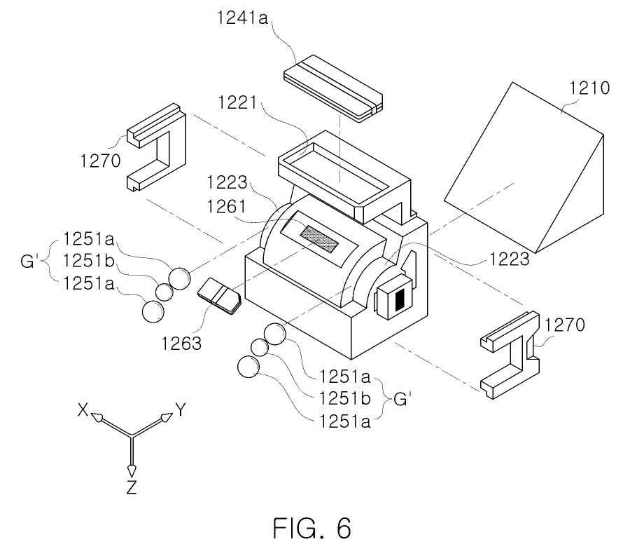

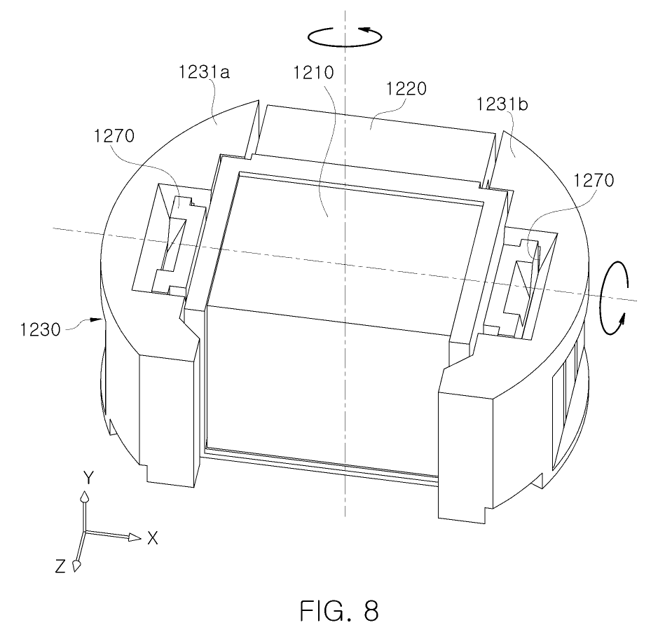

FIG. 4A, FIG. 4B, FIG. 5A, and FIG. 5B are exploded perspective views of reflective modules according to one or more embodiments of the present disclosure, FIG. 6 is an exploded perspective view of a reflective holder according to one or more embodiments of the present disclosure, and FIG. 8 is a perspective view illustrating a state in which a reflective holder according to one or more embodiments of the present disclosure is supported on a rotating carrier.

Referring to FIG. 3 and the like, the reflective module 1200 may include a reflective holder 1220 in which the reflective member 1210 is disposed, and a rotating carrier 1230 in which the reflective holder 1220 is disposed.

The reflective holder 1220 may rotate around the first axis (X-axis) as a rotational axis. The rotation of the reflective holder 1220 about the first axis (X-axis) may be a relative rotation with respect to the rotating carrier 1230. Since the reflective member 1210 is disposed in the reflective holder 1220, the reflective member 1210 may be rotated together with the reflective holder 1220.

The rotating carrier 1230 may be rotated about the second axis (Y-axis) as the rotation axis. The rotation of the rotating carrier 1230 about the second axis (Y-axis) may be a relative rotation with respect to the housing 1010. Since the reflective holder 1220 is disposed in the rotating carrier 1230, the reflective holder 1220 may be rotated together with the rotating carrier 1230. Similarly, the reflective member 1210 disposed in the reflective holder 1220 may also be rotated together.

The reflective module 1200 may include a first driving unit that provides driving force to the reflective holder 1220.

The first driving unit may include a first magnet 1241a disposed in the reflective holder 1220 and a first coil 1241b disposed in the housing 1010 to face the first magnet 1241a. The first coil 1241b may be disposed in the housing 1010 via the main substrate 1070.

The reflective holder 1220 may include an extension 1221 that extends between the rotating carrier 1230 and the housing 1010 from the rear surface of the reflective holder 1220. The first magnet 1241a may be disposed on the extension 1221.

The first coil 1241b may be disposed on one side surface of the housing 1010 facing the extension 1221. A first through hole 1011a may be provided on one side surface of the housing 1010 to expose the first coil 1241b to the internal space of the housing 1010. The first magnet 1241a and the first coil 1241b may directly face each other through the first through hole 1011a.

The first magnet 1241a and the first coil 1241b may generate driving force to rotate the reflective holder 1220 about the first axis (X-axis) as the rotation axis.

For example, one side of the first magnet 1241a facing the first coil 1241b may include an N-pole (or S-pole), a neutral region, and an S-pole (or N-pole) provided along the rotational direction (Y-axis direction) of the reflective holder 1220. Accordingly, the reflective holder 1220 may be rotated with the first axis (X-axis) as the rotational axis by the electromagnetic interaction between the first magnet 1241a and the first coil 1241b.

A first position sensor 1241c that detects and feeds back the position of the reflective holder 1220 together with the first coil 1241b may be disposed on the main substrate 1070.

For example, the first position sensor 1241c may be provided as a Hall sensor. The first position sensor 1241c is disposed to face the neutral area of the first magnet 1241a, and may detect the position of the reflective holder 1220 by detecting the change in magnetic flux according to the driving of the reflective holder 1220.

In addition, a driving circuit element (Driver IC) that provides a driving signal to the first coil 1241b may be disposed on the main substrate 1070.

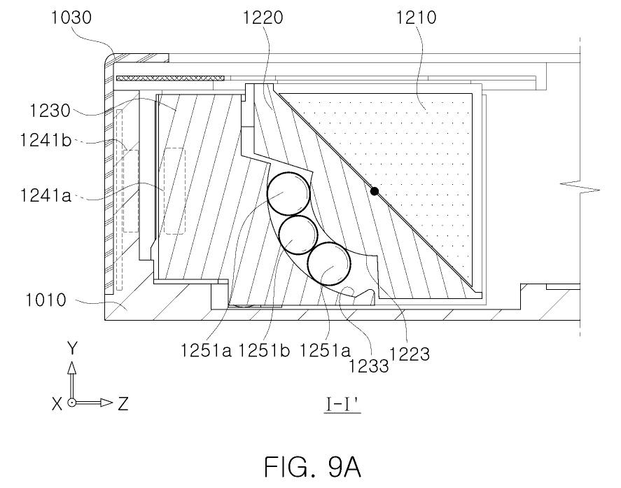

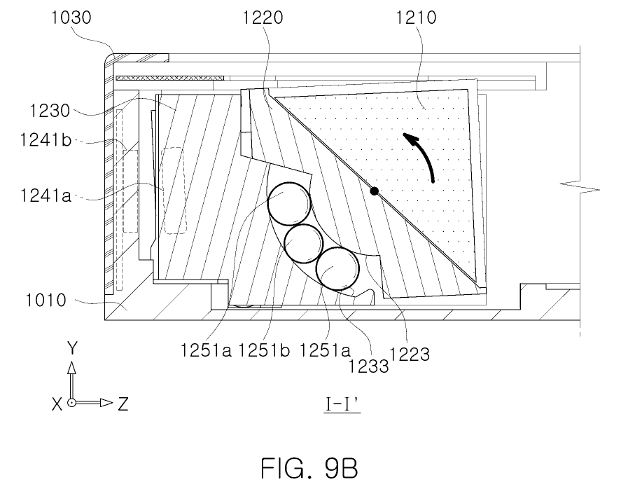

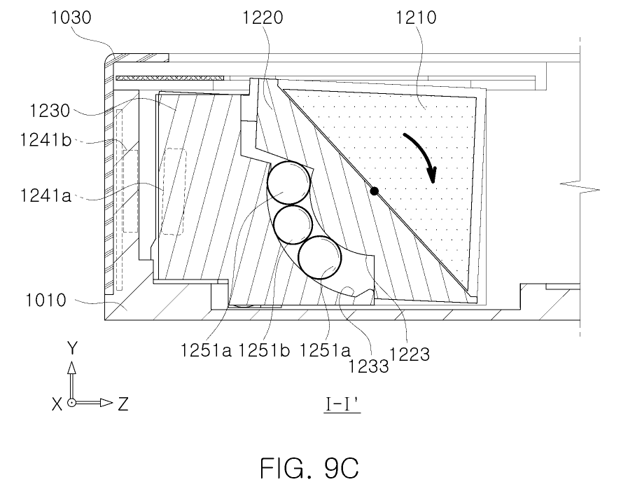

FIG. 9A is a cross-sectional view taken along line I-I’ of FIG. 1, and FIGS. 9B and 9C are drawings illustrating a reflective holder according to one or more embodiments of the present disclosure rotating around a first axis.

The reflective holder 1220 may be disposed on a rotating carrier 1230 with a plurality of ball members (hereinafter, first ball groups) 1251 interposed therebetween.

The first ball group 1251 may support the rotation of the reflective holder 1220 with the first axis (X-axis) as the rotation axis.

One side of the reflective holder 1220 and one side of the rotating carrier 1230 facing each other with the first ball group 1251 interposed therebetween may be rounded. For example, one side of the reflective holder 1220 and one side of the rotating carrier 1230 facing each other with the first ball group 1251 interposed therebetween may be shaped to correspond to portions of the side surfaces of cylinders having different radii and having the first axis (X-axis) as the rotation axis of the reflective holder 1220 as the central axis.

A plurality of first guide rails 1223 may be provided spaced apart in the direction of the first axis (X-axis) on one side of the reflective holder 1220. In addition, a plurality of second guide rails 1233 may be provided on one side of the rotating carrier 1230 to face a plurality of first guide rails 1223. The first ball group 1251 may be disposed between the first guide rails 1223 and the second guide rails 1233 facing each other.

Referring to FIGS. 4A and 4B, the first ball group 1251 may include a first ball member 1251a and a second ball member 1251b having different diameters. For example, the first ball member 1251a may have a larger diameter than a diameter of the second ball member 1251b.

The first ball member 1251a and the second ball member 1251b may each be provided in multiples. For example, the first ball member 1251a may be provided in greater numbers than the second ball member 1251b.

The first ball group 1251 may include a sub-group (G’) including one or more first ball members 1251a and a second ball member 1251b. The sub-groups (G’) may be disposed spaced apart from each other in the first axis (X-axis) direction and disposed between the first guide rail 1223 and the second guide rail 1233 facing each other.

In one or more embodiments of the present disclosure, the sub-group (G’) may include two first ball members 1251a and one second ball member 1251b. For example, the sub-group (G’) may include a first ball member 1251a, a second ball member 1251b, and a first ball member 1251a aligned in the length direction of the first guide rail 1223 and the second guide rail 1233.

The first ball member 1251a may contact the first guide rail 1223 and the second guide rail 1233, respectively. The first ball member 1251a may roll along the first guide rail 1223 and the second guide rail 1233 while contacting the first guide rail 1223 and the second guide rail 1233, respectively.

The first guide rail 1223 and the second guide rail 1233 may be in an arc shape centered on the first axis (X-axis). Therefore, the first ball member 1251a may roll along an arc-shaped trajectory centered on the first axis (X-axis).

The second ball member 1251b may respectively contact the two first ball members 1251a and roll along an arc-shaped trajectory centered on the first axis (X-axis) together with the first ball members 1251a. In detail, the second ball member 1251b may not contact the first guide rail 1223 and the second guide rail 1233.

The reflective holder 1220 may be rotated about the first axis (X-axis) along the rolling direction of the first ball member 1251a and the second ball member 1251b.

According to one or more embodiments of the present disclosure, the rotation of the reflective holder 1220 is supported by the rolling motion of the first ball group 1251 disposed apart from the first axis (X-axis), and the occurrence of sliding friction may be significantly reduced.

As the first ball member 1251a contacts the first guide rail 1223 and the second guide rail 1233, respectively, a gap may be provided between the reflective holder 1220 and the rotating carrier 1230.

One side of the reflective holder 1220 and one side of the rotating carrier 1230 facing each other with the first ball group 1251 therebetween may be separated from each other by the first ball member 1251a, and the rotating carrier 1230 may not interfere with the rotation of the reflective holder 1220.

Meanwhile, referring to FIGS. 5A and 5B, a first ball group 1251’ may include a plurality of first ball members 1251a. For example, the first ball group 1251’ may include four first ball members 1251a.

The four first ball members 1251a may be disposed between the first guide rail 1223 provided on the reflective holder 1220 and the second guide rail 1233’ provided on the rotating carrier 1230.

In one or more embodiments of the present disclosure, the first guide rail 1223 and the second guide rail 1233’ may be provided in different numbers. For example, the first guide rail 1223 may face two second guide rails 1233’. For example, the two second guide rails 1233’ may be provided spaced apart from each other in the length direction of the first guide rail 1231.

An intermediate protrusion 1233a may be provided between the second guide rails 1233’ spaced apart in the length direction of the first guide rail 1231 to separate the second guide rails 1233’ from each other.

According to one or more embodiments of the present disclosure, two first ball members 1251a may be disposed on the first guide rail 1223, and the first ball members 1251a may be disposed on the second guide rails 1233’, respectively. The first ball members 1251a disposed on the first guide rail 1223 may be disposed to be spaced apart from each other in the length direction of the first guide rail 1223, to be disposed on two second guide rails 1233’ facing the first guide rail 1223, respectively. In addition, the first ball members 1251a may be separated from each other by the intermediate protrusion 1233a while being disposed on the second guide rails 1233’.

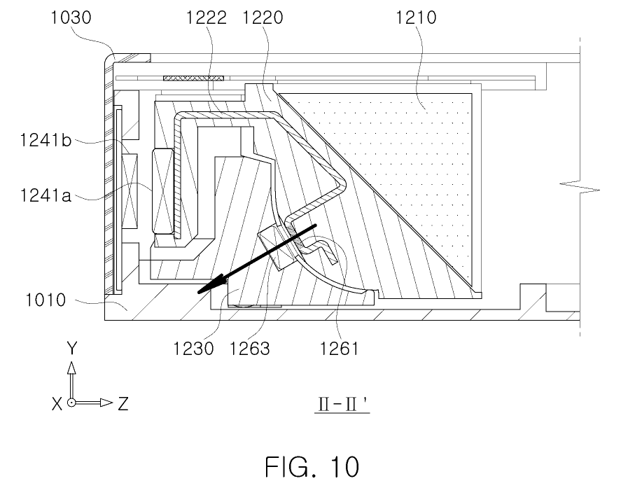

FIG. 10 is a cross-sectional view taken line II-II’ of FIG. 1.

The reflective holder 1220 may be supported on the rotating carrier 1230 in a direction facing the rotating carrier 1230 with the first ball group 1251 interposed therebetween.

To this end, a pair of magnetic members (hereinafter, the first magnetic member and the second magnetic member) 1261 and 1263 may be respectively disposed on one side of the reflective holder 1220 and one side of the rotating carrier 1230 facing each other with the first ball group 1251 therebetween.

In one or more embodiments of the present disclosure, one of the first magnetic member 1261 and the second magnetic member 1263 may be provided as a pulling magnet, and the other may be provided as a pulling yoke, and the first magnetic member 1261 and the second magnetic member 1263 may be disposed to face each other.

For example, the first magnetic member 1261 disposed in the reflective holder 1220 may be a pulling yoke, and the first magnetic member 1261 may be a portion of a reinforcing member 1222 inserted into the reflective holder 1220 to be described later. The second magnetic member 1263 disposed in the rotating carrier 1230 may be a pulling magnet, and the second magnetic member 1263 may be magnetized so that one side facing the first magnetic member 1261 has both a north pole and a south pole.

The first magnetic member 1261 and the second magnetic member 1263 may generate an attractive force in an opposing direction. The direction in which the first magnetic member 1261 and the second magnetic member 1263 face each other may be a direction intersecting (not perpendicular) to both the first axis (X-axis) and the second axis (Y-axis). The first magnetic member 1261 and the second magnetic member 1263 may face each other in an oblique direction to both the first axis (X-axis) and the second axis (Y-axis).

The reflective holder 1220 may be closely supported on the rotating carrier 1230 in a direction intersecting (not perpendicular) to both the first axis (X-axis) and the second axis (Y-axis) by the attractive force generated between the first magnetic member 1261 and the second magnetic member 1263. Accordingly, the first ball group 1251 may be maintained in a state of being sandwiched between the reflective holder 1220 and the rotating carrier 1230.

In one or more embodiments of the present disclosure, the reflective holder 1220 may be supported on the rotating carrier 1230 by a plurality of first ball members 1251a that are in contact with the reflective holder 1220 and the rotating carrier 1230, respectively.

The first magnetic member 1261 and the second magnetic member 1263 may be disposed inside a support area connecting the support points formed by the plurality of first ball members 1251a. For example, the point of action of the attractive force generated between the first magnetic member 1261 and the second magnetic member 1263 may be located inside the support area having a quadrangular shape.

Referring to FIGS. 4A-5B and FIG. 6, the reflective holder 1220 may include a reinforcing member 1222 inserted into the reflective holder 1220. For example, the reinforcing member 1222 may be insert-molded into the reflective holder 1220.

A portion of the reinforcing member 1222 may be exposed to the outside of the reflective holder 1220. A portion of the reinforcing member 1222 exposed to the outside of the reflective holder 1220 may face the second magnetic member 1263. For example, a portion of the reinforcing member 1222 may correspond to the first magnetic member 1261 that generates an attractive force with the second magnetic member 1263.

The reinforcing member 1222 may serve to focus the magnetic flux of the first magnet 1241a. In addition, the reinforcing member 1222 may also serve to dissipate heat generated from the first magnet 1241a.

Meanwhile, the reflective module 1200 may include an auxiliary member 1270 coupled to the rotating carrier 1230 to surround a portion of the reflective holder 1220.

In one or more embodiments of the present disclosure, the auxiliary members 1270 may be disposed as a pair to surround both sides of the reflective holder 1220 that are spaced apart from each other in the first axis (X-axis) direction. The auxiliary members 1270 may be fitted into coupling grooves 1232 provided in the rotating carrier 1230 while surrounding both sides of the reflective holder 1220. The auxiliary members 1270 may be disposed at a distance from the reflective holder 1220 so as not to interfere with the rotation of the reflective holder 1220 relative to the rotating carrier 1230.

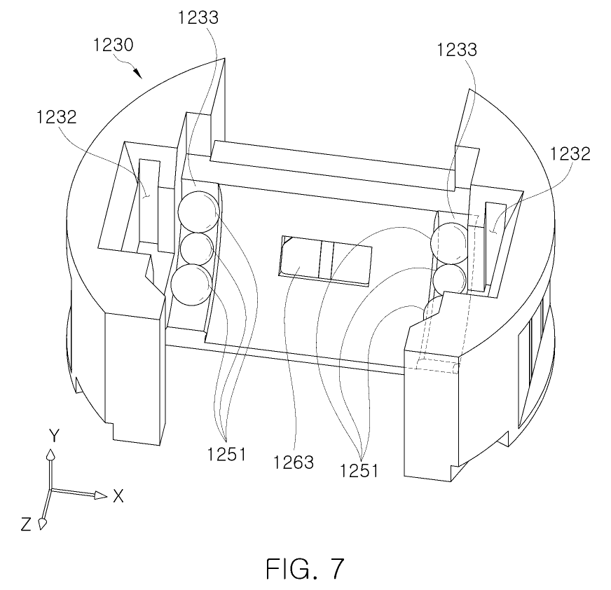

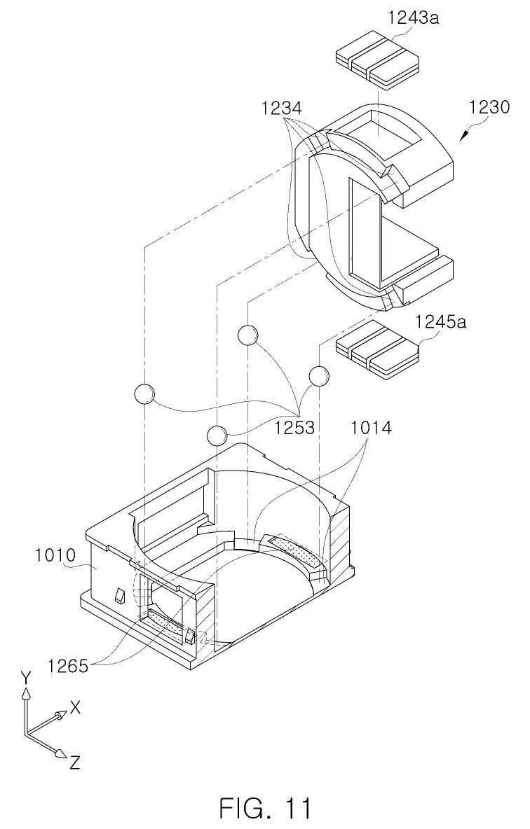

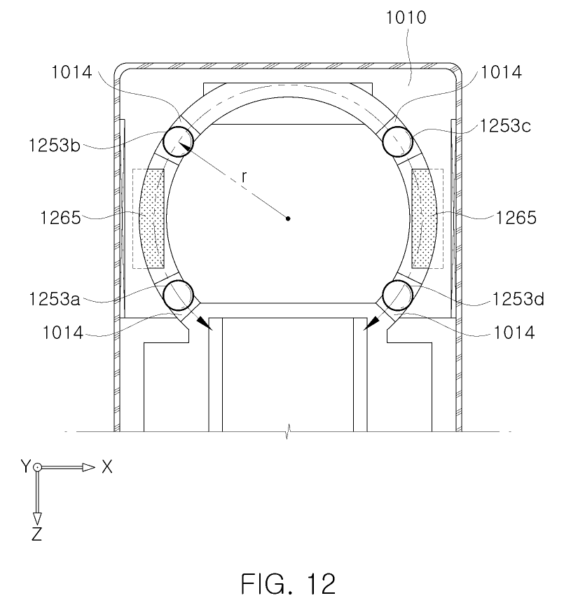

FIG. 7 is a perspective view of a rotating carrier according to one or more embodiments of the present disclosure, FIG. 11 is an exploded perspective view of a rotating carrier according to one or more embodiments of the present disclosure, and FIG. 12 is a drawing of a bottom surface of a housing according to one or more embodiments of the present disclosure.

The reflective module 1200 may include a second driving unit that provides driving force to the rotating carrier 1230.

The second driving unit may include a second magnet 1243a disposed in the rotating carrier 1230 and a second coil 1243b disposed in the housing 1010 to face the second magnet 1243a. The second coil 1243b may be disposed in the housing 1010 via the main substrate 1070.

The rotating carrier 1230 may include two side surfaces 1231a and 1231b having a round shape and spaced apart from each other in the direction of the first axis (X-axis) with the reflective member 1210 therebetween. For example, the two side surfaces 1231a and 1231b of the rotating carrier 1230 may have a shape corresponding to portions of side surfaces of a cylinder having an arbitrary radius and having the second axis (Y-axis), which is the rotational axis of the rotating carrier 1230, as the central axis.

In one or more embodiments of the present disclosure, a second magnet 1243a may be disposed on one side surface (the first side surface) 1231a of the two side surfaces 1231a and 1231b of the rotating carrier 1230, and a third magnet 1245a may be disposed on the other side surface (the second side surface) 1231b.

The second coil 1243b may be disposed on one side surface of the housing 1010 facing the one side surface 1231a of the rotating carrier 1230 on which the second magnet 1243a is disposed. The one side surface of the housing 1010 on which the second coil 1243b is disposed may be a different surface from the one side surface of the housing 1010 on which the first coil 1241b is disposed.

A second through hole 1011b may be provided in one side surface of the housing 1010 where the second coil 1243b is disposed to expose the second coil 1243b to the internal space of the housing 1010. The second magnet 1243a and the second coil 1243b may directly face each other through the second through hole 1011b.

In another embodiment, the second coil 1243b may be respectively disposed on two side surfaces of the housing 1010 facing the two side surfaces 1231a and 1231b of the rotating carrier 1230, and may face the second magnet 1243a and the third magnet 1245a.

The second magnet 1243a and the second coil 1243b may generate driving force to rotate the rotating carrier 1230 with the second axis (Y-axis) as the rotation axis.

For example, one side of the second magnet 1243a facing the second coil 1243b may include an N-pole, a neutral region, and a S-pole provided along the rotation direction (Z-axis direction) of the rotating carrier 1230. Referring to FIGS. 5A and 5B and the like, the second magnet 1243a may include an N-pole (or S-pole), a neutral region, an S-pole (or N-pole), a neutral region, and an N-pole (or S-pole) along the rotation direction (Z-axis direction) of the rotating carrier 1230. Accordingly, the rotating carrier 1230 may be rotated with the second axis (Y-axis) as the rotation axis by the electromagnetic interaction between the second magnet 1243a and the second coil 1243b. In addition, the second magnet 1243a may also play the role of a sensing magnet that senses the position of the rotating carrier 1230 by having a three-polarization type.

A second position sensor 1243c that detects and feeds back the position of the rotating carrier 1230 together with the second coil 1243b may be disposed on the main substrate 1070.

For example, the second position sensor 1243c may be equipped with a driver circuit element (Driver IC) including a Hall sensor function. The second position sensor 1243c is disposed to face the neutral area of the second magnet 1243a, and may detect the position of the rotating carrier 1230 by detecting the change in magnetic flux according to the driving of the rotating carrier 1230.

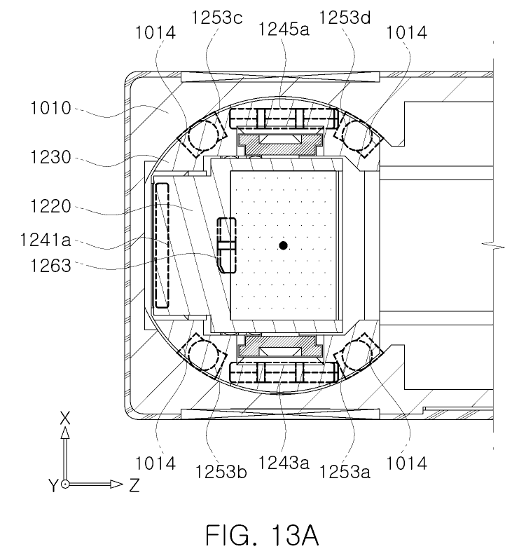

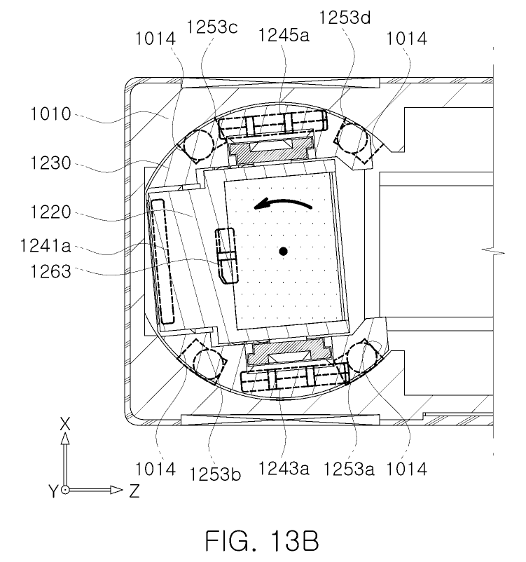

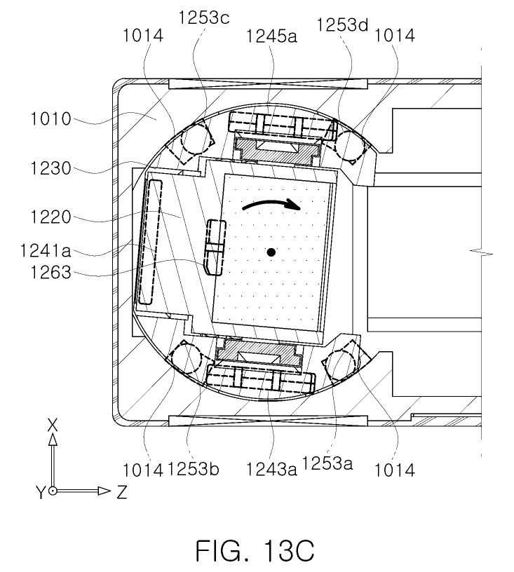

FIG. 13A is a plan view of a reflective module according to one or more embodiments of the present disclosure, and FIGS. 13B and 13C are drawings illustrating the rotating carrier according to one or more embodiments of the present disclosure rotating around the second axis.

The rotating carrier 1230 may be disposed in the housing 1010 with a plurality of ball members (hereinafter, second ball groups) 1253 interposed therebetween.

The second ball group 1253 may support the rotation of the rotating carrier 1230 with the second axis (Y-axis) as the rotation axis.

The bottom surface of the rotating carrier 1230 and the bottom surface of the housing 1010 may face each other with the second ball group 1253 therebetween.

A plurality of first guide grooves 1234 may be provided on the bottom surface of the rotating carrier 1230, and a plurality of second guide grooves 1014 may be provided on the bottom surface of the housing 1010 to face the plurality of first guide grooves 1234. The second ball group 1253 may be disposed between the first guide groove 1234 and the second guide groove 1014 facing each other.

The second ball group 1253 may include four ball members 1253a, 1253b, 1253c and 1253d that are disposed to be spaced apart from each other in a circumferential direction of a circle centered on the second axis (Y-axis). For example, two ball members 1253a and 1253b among the four ball members 1253a, 1253b, 1253c and 1253d may be disposed on a side surface 1231a of the rotating carrier 1230 where the second magnet 1243a is disposed, and the other two ball members 1253c and 1253d may be disposed on a side surface 1231b of the rotating carrier 1230 where the third magnet 1245a is disposed.

The four ball members 1253a, 1253b, 1253c and 1253d may be in contact with the first guide groove 1234 and the second guide groove 1014, respectively. The four ball members 1253a, 1253b, 1253c and 1253d may roll along the first guide groove 1234 and the second guide groove 1014 while being in contact with the first guide groove 1234 and the second guide groove 1014, respectively.

For example, the first guide groove 1234 and the second guide groove 1014 may be portions of a circle centered on the second axis (Y-axis) and having an arbitrary radius (r). The first guide groove 1234 and the second guide groove 1014 may be in the shape of an arc centered on the second axis (Y-axis). Alternatively, the first guide groove 1234 and the second guide groove 1014 may be in the shape of a straight line having a length in the tangent direction of the aforementioned circle. For example, the first guide groove 1234 and the second guide groove 1014 may be in the shape extended approximately along the rotational direction of the rotating carrier 1230.

The rotating carrier 1230 may be rotated about the second axis (Y-axis) in the direction in which the four ball members 1253a, 1253b, 1253c and 1253d roll.

According to one or more embodiments of the present disclosure, the rotation of the rotating carrier 1230 is supported by the rolling motion of the second ball group 1253 disposed apart from the second axis (Y-axis), and the occurrence of sliding friction may be significantly reduced.

Meanwhile, as the four ball members 1253a, 1253b, 1253c and 1253d contact the first guide groove 1234 and the second guide groove 1014, respectively, a gap may be provided between the rotating carrier 1230 and the housing 1010.

The bottom surface of the rotating carrier 1230 and the bottom surface of the housing 1010 facing each other with the second ball group 1253 therebetween may be separated from each other by four ball members 1253a, 1253b, 1253c and 1253d, and the housing 1010 may not interfere with the rotation of the rotating carrier 1230.

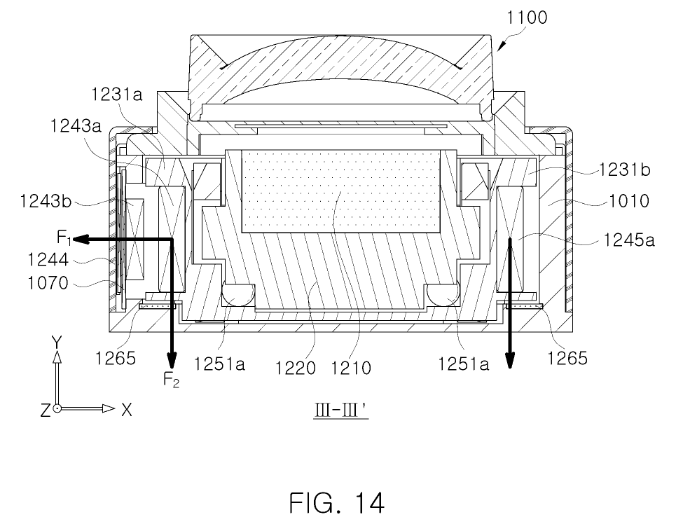

FIG. 14 is a cross-sectional view of III-III’ of FIG. 1.

The rotating carrier 1230 may be supported on the housing 1010 in a direction facing the housing 1010 with the second ball group 1253 therebetween.

The rotating carrier 1230 may face the housing 1010 in the second axis (Y-axis) direction with the second ball group 1253 therebetween, and a magnetic member may be disposed in the rotating carrier 1230 and the housing 1010 to generate an attractive force in the second axis (Y-axis) direction.

In one or more embodiments of the present disclosure, the rotating carrier 1230 may have a second magnet 1243a and a third magnet 1245a disposed, and the housing 1010 may have a third magnetic member 1265 disposed at a position facing the second magnet 1243a and the third magnet 1245a in the second axis (Y-axis) direction, respectively.

Referring to FIG. 14, the second magnet 1243a and the third magnet 1245a may be disposed on both side surfaces 1231a and 1231b of the rotating carrier 1230, spaced apart from each other in the first axis (X-axis) direction. The third magnetic member 1265 may be provided as a pair of pulling yokes spaced apart from each other in the first axis (X-axis) direction on the bottom surface of the housing 1010 to generate an attractive force with the second magnet 1243a and the third magnet 1243b.

The second magnet 1243a and the third magnet 1245a may be provided as the same magnet.

In one or more embodiments of the present disclosure, the second magnet 1243a and the third magnet 1245a may be provided with an N-pole (or S-pole), a neutral region, an S-pole (or N-pole), a neutral region, and an N-pole (or S-pole) along the length direction, and an N-pole and a S-pole along the width direction. However, in another embodiment, the third magnet 1245a may be provided with a magnet different from the second magnet 1243a.

The second magnet 1243a and the third magnet 1245a may generate an attractive force in the second axis (Y-axis) direction facing the third magnetic member 1265. The rotating carrier 1230 may be supported in close contact with the housing 1010 in the second axis (Y-axis) direction by the attractive force generated therebetween. Accordingly, the second ball group 1253 may be maintained sandwiched between the rotating carrier 1230 and the housing 1010.

Meanwhile, in the housing 1010, a yoke 1244 may be disposed to face a second magnet 1243a with a second coil 1243b therebetween. The second magnet 1243a may additionally generate an attractive force with the yoke 1244 in addition to the third magnetic member 1265.

The yoke 1244 may be disposed to cover a side of the main substrate 1070, opposite to one side of the main substrate 1070 on which the second coil 1243b and the like are mounted. Accordingly, the yoke 1244 may face the second magnet 1243a in the first axis (X-axis) direction, and the second magnet 1243a and the yoke 1244 may generate an attractive force in the first axis (X-axis) direction, which is the direction in which they face each other.

In one or more embodiments of the present disclosure, a force F1 generated in the first axis (X-axis) direction by the second magnet 1243a and the yoke 1244, and a force F2 generated in the second axis (Y-axis) direction by the second magnet 1243a and the third magnetic member 1265 may act on one side surface 1231a of the rotating carrier 1230. Accordingly, one side surface 1231a of the rotating carrier 1230 may be supported on the housing 1010 in a diagonal direction, which is the direction of the resultant force of the two forces.

The magnitude of the force acting on one side surface 1231a where the second magnet 1243a of the rotating carrier 1230 is disposed may be greater than the magnitude of the force acting on one side surface 1231b where the third magnet 1245a of the rotating carrier 1230 is disposed.

Accordingly, among the four ball members 1253a, 1253b, 1253c and 1253d disposed between the aforementioned rotating carrier 1230 and the housing 1010, two ball members 1253a and 1253b disposed close to the second magnet 1243a may serve as main guides, and two ball members 1253c and 1253d disposed close to the third magnet 1245a may serve as auxiliary guides.

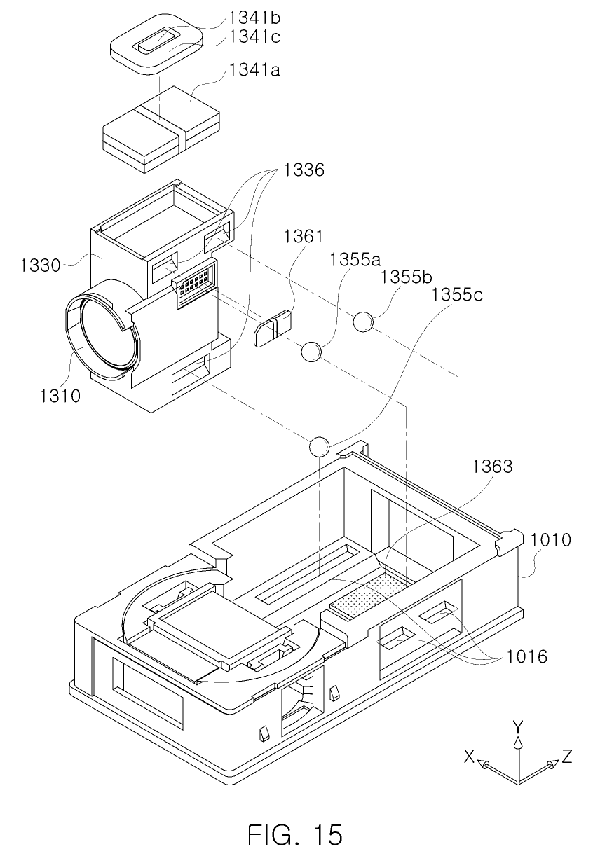

FIG. 15 is an exploded perspective view of a lens module according to one or more embodiments of the present disclosure.

Referring to FIG. 15, the second lens module 1300 may include a second lens barrel 1310 on which a plurality of lenses stacked in the direction of the second optical axis OA2 are mounted, and a second lens holder 1330 on which the second lens barrel 1310 is mounted.

However, in another embodiment, the second lens barrel 1310 may be omitted, and the plurality of lenses may be directly mounted on the second lens holder 1330.

In another embodiment, the second lens holder 1330 may be omitted, and the second lens barrel 1310 may be provided in plural. One or more lenses may be mounted on the plurality of second lens barrels 1310, and the plurality of second lens barrels 1310 may be disposed in the direction of the second optical axis OA2.

Referring again to FIG. 15, the second lens holder 1330 may be accommodated in the internal space of the housing 1010 to be movable in the direction of the second optical axis OA2. Hereinafter, the direction of the second optical axis OA2 may be described as the direction of the third axis (Z-axis). The third axis (Z-axis) may be an axis perpendicular to both the first axis (X-axis) and the second axis (Y-axis).

The second lens module 1300 may include a lens module driving unit that provides driving force to the second lens holder 1330.

The lens module driving unit may include a driving magnet 1341a disposed in the second lens holder 1330 and a driving coil 1341b disposed in the housing 1010 to face the driving magnet 1341a. The driving coil 1341b may be disposed in the housing 1010 via the main substrate 1070.

The driving magnet 1341a may be disposed on one or both side surfaces of the second rotating holder 1330. The driving coil 1341b may be disposed on one side surface of the housing 1010 that faces one or both side surfaces of the second lens holder 1330 where the driving magnet 1341a is disposed. A third through hole 1011c may be disposed in one side surface of the housing 1010 where the driving coil 1341b is disposed to expose the driving coil 1341b to the internal space of the housing 1010. The driving magnet 1341a and the driving coil 1341b may directly face each other through the third through hole 1011c.

The driving magnet 1341a and the driving coil 1341b may generate driving force to move the second lens holder 1330 in the third axis (Z-axis) direction.

For example, the driving magnet 1341a and the driving coil 1341b may face each other in the first axis (X-axis) direction, and one side of the driving magnet 1341a facing the driving coil 1341b may include an N-pole (or S-pole), a neutral region, and an S-pole (or N-pole) provided along the moving direction (Z-axis direction) of the second lens holder 1330. Accordingly, the second lens holder 1330 may move in the third axis (Z-axis) direction due to the electromagnetic interaction between the driving magnet 1341a and the driving coil 1341b.

A third position sensor 1341c that detects and feeds back the position of the second lens holder 1330 together with the driving coil 1341b may be disposed on the main substrate 1070.

For example, the third position sensor 1341c is disposed to face the neutral area of the third magnet 1341a, and may detect the position of the second lens holder 1330 by detecting a change in magnetic flux according to the driving of the second lens holder 1330.

In addition, a driving circuit element (Driver IC) that provides a driving signal to the second coil 1341b may be disposed on the main substrate 1070.

The second lens holder 1330 may be disposed in the housing 1010 with a plurality of ball members (hereinafter, third ball group) 1355 interposed therebetween.

The third ball group 1355 may support the movement of the second lens holder 1330 that translates along the third axis (Z-axis).

The bottom surface of the second lens holder 1330 and the bottom surface of the housing 1010 may face each other with the third ball group 1355 therebetween.

A plurality of third guide grooves 1336 may be provided on the bottom surface of the second lens holder 1330, and a plurality of fourth guide grooves 1016 may be provided on the bottom surface of the housing 1010 to face the plurality of third guide grooves 1336. The third ball group 1355 may be disposed between the third guide grooves 1336 and the fourth guide grooves 1016 facing each other.

The third ball group 1355 may include three or more ball members, and may include, for example, three ball members 1355a, 1355b and 1355c. Among three ball members 1355a, 1355b and 1355c, two ball members 1355a and 1355b may be disposed on one side of the second lens holder 1330, and the remaining one ball member 1355c may be disposed on the other side located opposite to the one side of the second lens holder 1330 with respect to the third axis (Z-axis). For example, among three ball members 1355a, 1355b and 1355c, two ball members 1355a and 1355b may be disposed on one side of the second lens holder 1330 where the driving magnet 1341a is disposed, and the remaining one ball member 1355c may be disposed on the side opposite thereto.

The three ball members 1355a, 1355b and 1355c may be in contact with the third guide groove 1336 and the fourth guide groove 1016, respectively. The three ball members 1355a, 1355b and 1355c may roll along the third guide groove 1336 and the fourth guide groove 1016 while being in contact with the third guide groove 1336 and the fourth guide groove 1016, respectively.

For example, the third guide groove 1336 and the fourth guide groove 1016 may be in the form of straight lines having a length parallel to the third axis (Z-axis).

The second lens holder 1330 may be moved in the direction of the third axis (Z-axis) along the direction in which the three ball members 1355a, 1355b and 1355c roll.

Meanwhile, a gap may be provided between the second lens holder 1330 and the housing 1010 as the three ball members 1355a, 1355b and 1355c come into contact with the third guide groove 1336 and the fourth guide groove 1016, respectively.

The bottom surface of the second lens holder 1330 and the bottom surface of the housing 1010 facing each other with the third ball group 1355 therebetween may be spaced apart from each other by the three ball members 1355a, 1355b and 1355c, and the housing 1010 may not interfere with the movement of the second lens holder 1330.

The second lens holder 1330 may be supported on the housing 1010 in a direction facing the housing 1010 with the third ball group 1355 therebetween.

To this end, a pair of magnetic members (hereinafter, the fourth magnetic member and the fifth magnetic member) 1361 and 1363 may be disposed on the bottom surface of the second lens holder 1330 and the bottom surface of the housing 1010 facing each other with the third ball group 1355 therebetween.

One of the fourth magnetic member 1361 and the fifth magnetic member 1363 may be provided as a pulling magnet, and the other may be provided as a pulling yoke, and the fourth magnetic member 1361 and the fifth magnetic member 1363 may be disposed to face each other. For example, the fourth magnetic member 1361 may be provided as a pulling magnet and disposed in the second lens holder 1330. The fifth magnetic member 1363 may be provided as a pulling yoke and disposed in the housing 1010. The pulling magnet may be magnetized so that one surface facing the pulling yoke has both an N-pole and a S-pole.

The fourth magnetic member 1361 and the fifth magnetic member 1363 may generate an attractive force in the direction of the second axis (Y-axis) which is the direction in which they face each other. The second lens holder 1330 may be supported in the second axis (Y-axis) direction by the attractive force generated between the fourth magnetic member 1361 and the fifth magnetic member 1363. Accordingly, the third ball group 1355 may be maintained in a state of being inserted between the second lens holder 1330 and the housing 1010.

In one or more embodiments of the present disclosure, the fourth magnetic member 1361 may be disposed in the second lens holder 1330, and the fifth magnetic member 1363 may be disposed in the housing 1010. The fourth magnetic member 1361 and the fifth magnetic member 1363 may be disposed inside a triangular support area connecting three support points formed by three ball members 1355a, 1355b and 1355c. For example, the point of action of the attractive force occurring between the fourth magnetic member 1361 and the fifth magnetic member 1363 may be located within the support area having a triangular shape.

In one or more embodiments of the present disclosure, the fourth magnetic member 1361 may be disposed to be biased toward two ball members 1355a and 1355b among the three ball members 1355a, 1355b and 1355c. The two ball members 1355a and 1355b disposed relatively closer to the fourth magnetic member 1361 may serve as main guides.

The fifth magnetic member 1363 may have a larger area than the area of the fourth magnetic member 1361. In detail, the fifth magnetic member 1363 may be formed with an area that may cover the range of movement of the fourth magnetic member 1361 so that a force of attraction may be continuously applied between the fourth magnetic member 1361 and the fifth magnetic member 1363 while the second lens holder 1330 moves in the third axis (Z-axis) direction relative to the housing 1010.

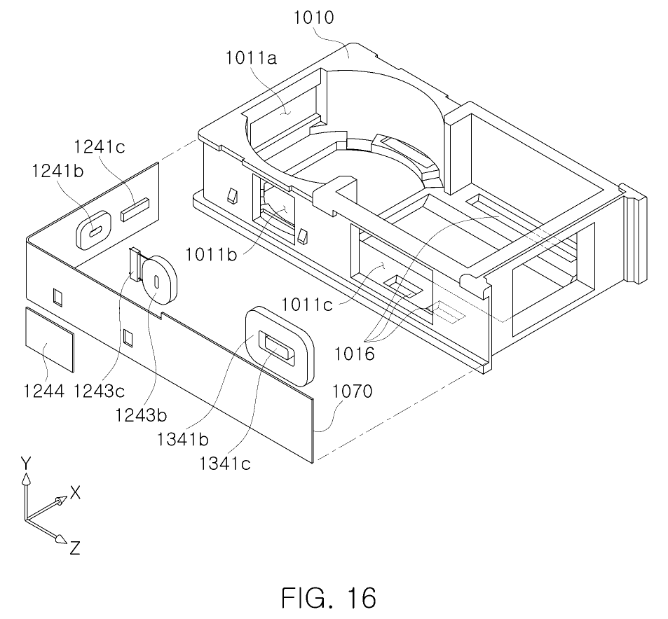

FIG. 16 is a perspective view of a main substrate according to one or more embodiments of the present disclosure.

Referring to FIG. 16, a main substrate 1070 equipped with a portion of a driving unit configured to drive the second lens module 1300 and a reflective module 1200 may be attached to an outer surface of the housing 1010. As described above, a coil, a position sensor, a driving circuit element, and the like may be disposed on the main substrate 1070.

In one or more embodiments of the present disclosure, the main substrate 1070 may be partially, flexibly provided and disposed across two side surfaces of the housing 1010. However, the shape of the main substrate 1070 may vary depending on the arrangement of the driving unit.

The main substrate 1070 may be electrically connected to a sensor substrate that is mounted with an image sensor and is attached to another outer surface of the housing 1010.

As set forth above, according to one or more embodiments of the present disclosure, a resolution degradation of an image may be significantly reduced during image stabilization, and the ability to compensate for fine shake during high magnification shooting may be improved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a reflective module, the reflective module comprising:
a housing;
a reflective holder configured to rotate about a first axis;
a reflective member disposed on the reflective holder;
a rotating carrier configured to rotate about a second axis perpendicular to the first axis, wherein the reflective holder is disposed on the rotating carrier;
a first ball group disposed between the reflective holder and the rotating carrier and comprising a plurality of ball members spaced apart from the first axis; and
a second ball group disposed between the rotating carrier and the housing and comprising a plurality of ball members spaced apart from the second axis,
wherein the first axis and the second axis pass through the rotating carrier.

2. The camera module of claim 1, further comprising a first lens module containing at least one lens disposed in a first optical axis direction and disposed apart from the reflective module in the first optical axis direction,
wherein the first optical axis direction is parallel to the second axis.

3. The camera module of claim 2, wherein the first lens module is a fixed member coupled to the housing, and the reflective module is configured to rotate relative to the housing and the first lens module.

4. The camera module of claim 1, wherein the reflective holder comprises first guide rails having an arc shape centered on the first axis and disposed apart from each other in a direction of the first axis,
wherein the rotating carrier comprises second guide rails having an arc shape centered on the first axis and facing the first guide rails, and
wherein the first ball group is disposed between the first guide rails and the second guide rails.

5. The camera module of claim 4, wherein the first ball group comprises a plurality of first ball members respectively contacting the first guide rails and the second guide rails, and
wherein the plurality of first ball members are disposed on the first guide rail, and at least one of the plurality of first ball members is disposed on each of the second guide rails.

6. The camera module of claim 5, wherein the second guide rail comprises a plurality of rails spaced apart in a rotational direction of the reflective holder, and
wherein the first guide rail faces the plurality of rails.

7. The camera module of claim 5, wherein the first ball group further comprises one or more second ball members each having a diameter smaller than a diameter of each of the plurality of first ball members, and
wherein a number of first ball members of the plurality of first ball members is greater than a number of second ball members of the one or more second ball members.

8. The camera module of claim 1, wherein a first magnetic member is disposed on the reflective holder, and a second magnetic member facing the first magnetic member is disposed on the rotating carrier, and
wherein the first magnetic member and the second magnetic member face each other in an oblique direction to the first axis and the second axis.

9. The camera module of claim 1, wherein the rotating carrier comprises a plurality of first guide grooves spaced apart from each other in a circumferential direction of a circle having an arbitrary radius centered on the second axis,
wherein the housing comprises a plurality of second guide grooves facing the plurality of first guide grooves, and
wherein the second ball group is disposed between the plurality of first guide grooves and the plurality of second guide grooves.

10. The camera module of claim 9, wherein the plurality of first guide grooves and the plurality of second guide grooves are in a form extending along a rotational direction of the rotating carrier.

11. The camera module of claim 1, wherein the rotating carrier comprises a first side surface and a second side surface disposed apart from each other with the reflective member therebetween,
wherein the first side surface and the second side surface are rounded along a rotational direction of the rotating carrier.

12. The camera module of claim 11, wherein a first magnet is disposed on the first side surface of the rotating carrier, and a second magnet is disposed on the second side surface of the rotating carrier, and
wherein a first coil facing the first magnet is disposed on the housing.

13. The camera module of claim 12, wherein a third magnetic member is disposed on the housing to face the first magnet and the second magnet, respectively, and
wherein the first magnet and the second magnet face the third magnetic member in a direction perpendicular to a direction in which the first magnet and the first coil face each other.

14. The camera module of claim 13, further comprising a yoke disposed on the housing to face the first magnet with the first coil interposed therebetween.

15. The camera module of claim 1, further comprising a second lens module comprising at least one lens disposed in a second optical axis direction, and disposed spaced apart from the reflective module in the second optical axis direction,
wherein the second lens module is configured to move in the second optical axis direction relative to the housing.

16. A camera module comprising:
a housing having an internal space;
a first lens module comprising at least one lens; and
a reflective module disposed in the internal space and configured to change a path of light passing through the first lens module,
wherein the reflective module comprises:
a reflective holder configured to rotate about a first axis;
a reflective member disposed on the reflective holder;
a rotating carrier configured to rotate about a second axis perpendicular to the first axis, wherein the reflective holder is disposed on the rotating carrier; and
a plurality of ball members configured to roll in a rotational direction of the reflective holder and the rotating carrier when the reflective holder and the rotating carrier rotate.

17. The camera module of claim 16, wherein the plurality of ball members comprise a first ball group disposed between the reflective holder and the rotating carrier,
wherein ball members of the first ball group are configured to roll along the rotational direction of the reflective holder.

18. The camera module of claim 16, wherein the plurality of ball members comprise a second ball group disposed between the rotating carrier and the housing,
wherein ball members of the second ball group are configured to roll along the rotational direction of the rotating carrier.

19. The camera module of claim 16, wherein the first axis and the second axis pass through the rotating carrier.
